(19) United States
(12) Patent Application Publication
(10) Pub. No.: US 2003/0234477 A1
(43) Pub. Date: Dec. 25, 2003

(54) Hydraulic mount with compliant element in fluid chamber

(75) Inventors: Ronald A. Beer, Fairborn, OH (US); James P. Hamberg, Tipp City, OH (US); Brent W. Fourman, New Paris, OH (US); Frederick C. Miller, Beavercreek, OH (US); Michael Rizzo, Rochester Hills, MI (US)

Correspondence Address: SCOTT A. MCBAIN, DELPHI TECHNOLOGIES, INC., Legal Staff, Mail Code: 482-204-450, P.O. BOX 5052, Troy, MI, 48098, US

(73) Assignee: DELPHI TECHNOLOGIES INC.

(21) Appl. No.: 10/176,291

(22) Filed: Jun. 20, 2002

(51) Int. Cl. F16F 9/00

(52) U.S. Cl. 267/140.12

(57) ABSTRACT

A mount for a powertrain component of a motor vehicle comprises a primary chamber and a secondary chamber. An orifice track is in fluid communication between the primary chamber and the secondary chamber, and a compliant element is disposed in the primary chamber.

### TECHNICAL FIELD OF THE INVENTION

This invention relates to powertrain mounts for motor vehicles, and more particularly to a powertrain mount having a compliant element in the fluid chamber.

### BACKGROUND OF THE INVENTION

It is desirable to provide motor vehicles with improved operating smoothness by damping and/or isolating powertrain vibrations of the vehicle. A variety of mount assemblies are presently available to inhibit such engine and transmission vibrations. Many of these mount assemblies combine the advantageous properties of elastomeric materials with hydraulic fluids. A hydraulic mount assembly of this type typically includes a reinforced, hollow rubber body that is closed by a resilient diaphragm so as to form a cavity. This cavity is separated into two chambers by a plate. The chambers are in fluid communication through a relatively large central orifice in the plate. The first or primary chamber is formed between the partition plate and the body. The secondary chamber is formed between the plate and the diaphragm.

A decoupler may be positioned in the central passage of the plate to reciprocate in response to the vibrations. The decoupler movement alone accommodates small volume changes in the two chambers. When, for example, the decoupler moves in a direction toward the diaphragm, the volume of the portion of the decoupler cavity in the primary chamber increases and the volume of the portion in the secondary chamber correspondingly decreases, and vice-versa. In this way, for certain small vibratory amplitudes and generally higher frequencies, fluid flow between the chambers is substantially avoided and undesirable hydraulic damping is eliminated. In effect, this decoupler is a passive tuning device.

In addition to the relatively large central passage, an orifice track with a smaller, restricted flow passage is provided extending around the perimeter of the orifice plate. Each end of the track has an opening; one opening communicating with the primary chamber and the other with the secondary chamber. The orifice track provides the hydraulic mount assembly with another passive tuning component, and when combined with the decoupler, provides at least three distinct dynamic operating modes. The particular operating mode is primarily determined by the flow of fluid between the two chambers.

More specifically, small amplitude vibrating input, such as from relatively smooth engine idling or the like, produces no damping due to the action of the decoupler, as explained above. In contrast, large amplitude vibrating inputs, such as large suspension inputs, produce high velocity fluid flow through the orifice track, and an accordingly high level of damping force and desirable control and smoothing action. A third or intermediate operational mode of the mount occurs during medium amplitude inputs experienced in normal driving and resulting in lower velocity fluid flow through the orifice track.

### SUMMARY OF THE INVENTION

The present invention is a mount for a powertrain component of a motor vehicle. The mount comprises a primary chamber and a secondary chamber. An orifice track is in fluid communication between the primary chamber and the secondary chamber, and a compliant element is disposed in the primary chamber.

Accordingly, it is an object of the present invention to provide an improved hydraulic mount overcoming the limitations and disadvantages of the prior art.

Another object of the present invention is to provide a hydraulic mount of the type described above which has a relatively low dynamic rate with the ability to tune the dynamic rate at a selected frequency.

Still another object of the present invention is to provide an improved hydraulic mount of the type described above having a compliant element disposed in the primary chamber.

Still another object of the present invention is to provide an improved hydraulic mount of the type described above having a compliant element disposed in communication with the primary chamber.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a cross-sectional view of a powertrain mount according to the present invention for a motor vehicle;

FIG. 2 is a cross-sectional view of the mount taken along line 2—2 in FIG. 1; and

FIG. 3 is a cross-sectional view similar to FIG. 2 and showing an alternative embodiment of the mount.

### DETAILED DESCRIPTION OF THE PRESENTLY PREFERRED EMBODIMENT

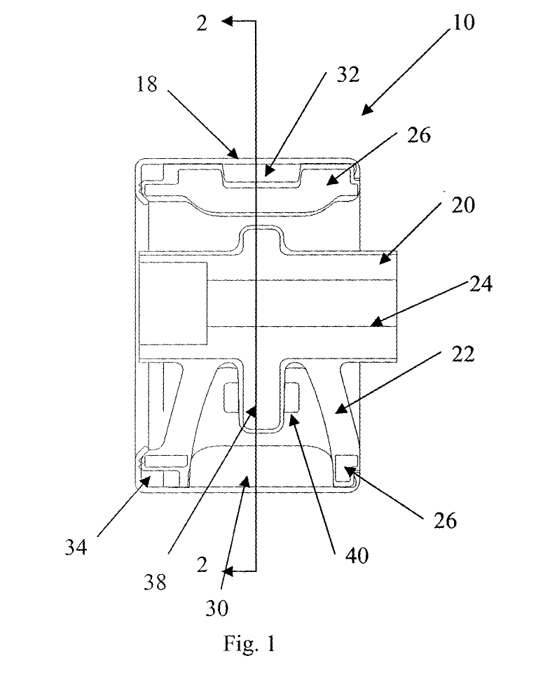

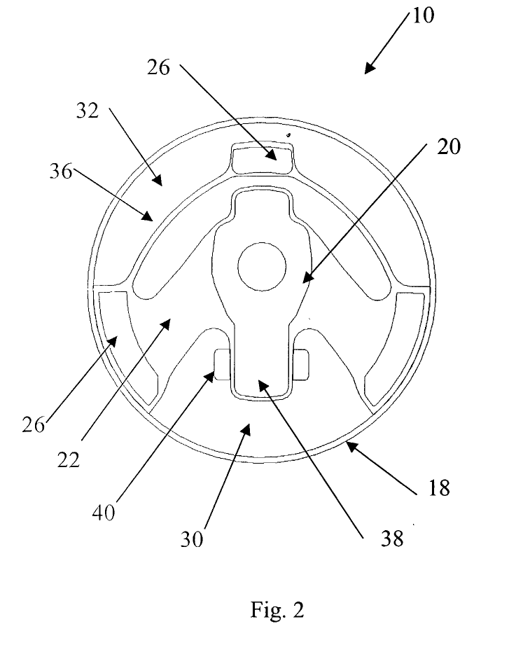

FIGS. 1 and 2 shows an improved hydraulic mount assembly 10 according to the present invention. The mount assembly 10 is particularly adapted for mounting an internal combustion engine and/or transmission to a frame in a vehicle. The mount assembly 10 includes a generally cylindrical body 18. An inner insert 20, preferably formed of metal or plastic, is supported inside the body 18 by one or more elastomeric legs 22. The inner insert 20 includes a bore 24 through which a fastener may extend to fasten the mount assembly 10 to the powertrain component or to the frame, as is well known. An outer insert 26 is disposed at least partially around the inner insert 20. The outer insert 26 may be formed from aluminum, steel, or plastic.

A pumping or primary chamber 30 is formed by the rubber legs 22. An elastomeric diaphragm 36 of natural or synthetic rubber partially defines a secondary chamber 32. The pumping chamber 30 is in fluid communication with the secondary chamber 32 through an orifice track 34. A finger 38 extends from the inner insert 20 into the pumping chamber 30. The finger 38 is covered with an elastomeric skin, and a compliant element 40 is attached around the skin of the finger so as to be disposed in the pumping chamber 30.

The chambers 30 and 32, and the orifice track 34, are filled with a damping liquid such as a glycol-based solution. In a preferred embodiment, the compliant element 40 is a closed-cell foam or a self-contained gas spring. The compliant element 40 is more compliant than the bulge stiffness of the elastomeric legs 22, which allows the mount assembly to accommodate the volume changes associated with small amplitude motions and results in a lower rate. Under large amplitude motion, the compliance of the foam is exceeded and it cannot accommodate the volume change. In this condition, fluid is forced through the orifice track 34, creating damping for motion control. In particular, the operating characteristics of the mount can be varied by changing the volume and/or density of the trapped air or foam comprising the compliant element 40.

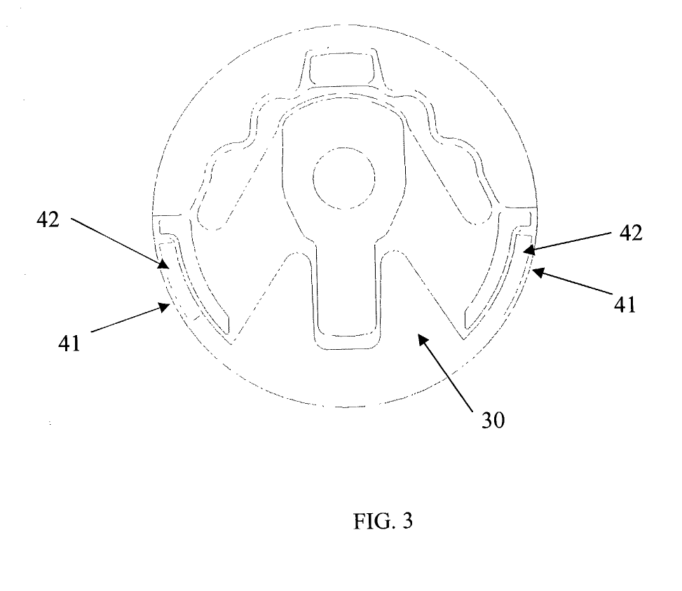

FIG. 3 shows an alternative embodiment of the mount assembly in which one or more cavities 41 are formed in communication with the pumping chamber 30. A compliant element 42, similar to the compliant element 40 discussed above with respect to FIGS. 1 and 2, is positioned in each of the cavities 41. In all other respects, the embodiment shown in FIG. 3 operates similarly to the embodiment of FIGS. 1 and 2.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1. A mount for a powertrain component of a motor vehicle, the mount comprising:
a primary chamber;
a secondary chamber;
an orifice track in fluid communication between the primary chamber and the secondary chamber; and
a compliant element disposed in the primary chamber.

2. The mount of claim 1 wherein the primary chamber includes at least one cavity.

3. The mount of claim 2 wherein the compliant element is disposed in the cavity.

4. The mount of claim 1 wherein the compliant element comprises foam.

5. The mount of claim 1 wherein the compliant element comprises closed-cell foam.

6. The mount of claim 1 wherein the compliant element comprises a gas spring.

7. The mount of claim 1 wherein the primary chamber is defined at least in part by one or more legs.

8. The mount of claim 7 wherein the one or more legs include a finger extending into the primary chamber.

9. The mount of claim 8 wherein the compliant element is connected to the finger.

10. A mount for a powertrain component of a motor vehicle, the mount comprising:
an inner insert;
at least one leg connected to the inner insert and defining at least in part a primary chamber;
a diaphragm connected to the at least one leg and defining at least in part a secondary chamber, the secondary chamber being in fluid communication with the primary chamber; and
a compliant element disposed in the primary chamber.

11. The mount of claim 10 wherein the primary chamber includes at least one cavity.

12. The mount of claim 10 wherein the compliant element is disposed in the cavity.

13. The mount of claim 10 wherein the compliant element comprises foam.

14. The mount of claim 10 wherein the compliant element comprises closed-cell foam.

15. The mount of claim 10 wherein the compliant element comprises a gas spring.

16. The mount of claim 10 wherein the primary and secondary chambers are in communication through an orifice track.

17. The mount of claim 10 wherein the at least one leg includes a finger extending into the primary chamber.

18. The mount of claim 17 wherein the compliant element is connected to the finger.

19. The mount of claim 11 wherein the diaphragm is elastomeric.

20. A mount for a powertrain component of a motor vehicle, the mount comprising:
an inner insert;
at least one elastomeric leg connected to the inner insert and defining at least in part a primary chamber, the primary chamber having at least one cavity;
an elastomeric diaphragm connected to the at least one leg and defining at least in part a secondary chamber, the secondary chamber being in fluid communication with the primary chamber through an orifice track; and
a compliant element disposed in the at least one cavity.
